(19) United States
(12) Patent Application Publication
(10) Pub. No.: US 2023/0104827 A1
(43) Pub. Date: Apr. 6, 2023

(54) ELECTRONIC DEVICES WITH FLEX-PROTECTION MECHANISMS

(71) Applicant: HEWLETT-PACKARD DEVELOPMENT COMPANY, L.P., Spring, TX (US)

(72) Inventors: Oliver Nicholas POYNTZ, London (GB); Benjamin CARROLL, London (GB); Cian PLUMBE, London (GB); Marcus HOGGARTH, London (GB); Mark SENATORI, Spring, TX (US); Dong Ryul CHA, Spring, TX (US)

(73) Assignee: HEWLETT-PACKARD DEVELOPMENT COMPANY, L.P., Spring, TX (US)

(21) Appl. No.: 17/495,452

(22) Filed: Oct. 6, 2021

(51) Int. Cl. G06F 1/16

(52) U.S. Cl. CPC G06F 1/1681; G06F 1/1616; G06F 1/1679

(57) ABSTRACT

An example electronic device comprises a first portion including a display, a second portion, a hinge movably coupling the first portion to the second portion, and a flex-protection mechanism. The flex-protection mechanism includes a first magnetic component, a retractable bumper coupled to a second magnetic component, and a third magnetic component. In response to movement of the first portion between an open position and a closed position and magnetic interactions between the second magnetic component, the first magnetic component, and the third magnetic component, the retractable bumper moves between a retracted position and a protruded position.

### BACKGROUND

Electronic devices with displays may be used for a variety of purposes, such as for displaying information on the display. The electronic device may include a first portion having the display and a second portion which is movably coupled to the first portion, such that the electronic device is movable between an open position and a closed position.

### BRIEF DESCRIPTION OF THE DRAWINGS

FIG. 1 illustrates a diagram of an electronic device, in accordance with examples of the present disclosure.

FIGS. 2A-2D illustrate an electronic device, in accordance with examples of the present disclosure.

FIGS. 3A-3B illustrate another electronic device, in accordance with examples of the present disclosure.

FIGS. 4A-4B illustrate a flex-protection mechanism, in accordance with examples of the present disclosure.

FIG. 5 illustrates another electronic device, in accordance with examples of the present disclosure.

### DETAILED DESCRIPTION

In the following detailed description, reference is made to the accompanying drawings which form a part hereof, and in which is shown by way of illustration of specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Electronic devices may be used to disseminate information via a display (e.g., a screen) of the electronic device. In some examples, when the electronic device is moved to a closed position, the display of a first portion of the electronic device may be proximal to a second portion of the electronic device. While in the closed position, a user may place pressure on the electronic device by placing an object on the electronic device, or picking up the electronic device, among other reasons. The pressure provided on the electronic device may cause the display to flex, which may harm or stress the display. In some examples, the pressure may cause damage to the display, such as scratches to the display due to interactions with components on the second portion of the electronic device. In some instances, fixed rubber bumpers and/or pads may be disposed on the first portion and/or the second portion of the electronic device. The fixed bumpers and/or pads may be visible to the user, thereby impacting (e.g., negatively) the aesthetics of the electronic device, and in some instances, may still allow for the display to flex, such as with displays having dimensions above a threshold (e.g., are large).

Examples in accordance with the present disclosure are directed to a flex-protection mechanism integrated in the electronic device that prevents or mitigates display flexing when the electronic device is in a closed position. In some examples, the flex-protection mechanism may prevent damage to the display. The flex-protection mechanism includes a first magnetic component, a retractable bumper coupled to a second magnetic component, and a third magnetic component. The first magnetic component is positioned to magnetically attract the second magnetic component when the electronic device is in an open position and cause the retractable bumper to be in a retracted position, such that the bumper is hidden from view and/or is minimally visible. The third magnetic component is positioned to magnetically attract the second magnetic component when the electronic device is in a closed position and cause the retractable bumper to be in a protruded position, such that the retractable bumper extends from the one of the first portion and the second portion of the electronic device and is in contact with the other of the first portion and the second portion of the electronic device. The flex-protection mechanism may prevent or mitigate flexing of the display, and may be minimally visible or not visible to the user, thereby being aesthetically pleasing.

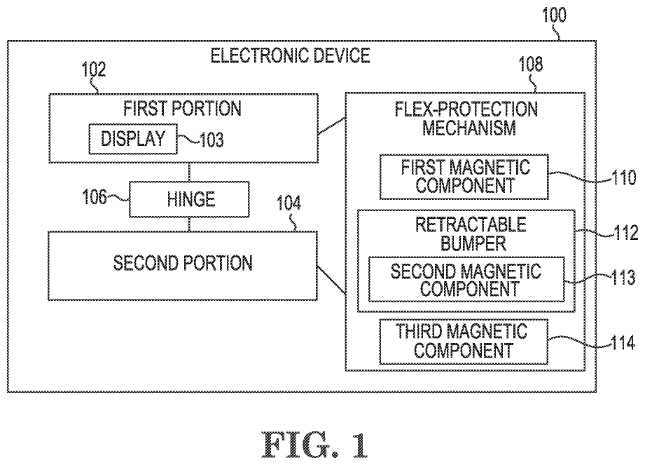

Turning now to the figures, FIG. 1 illustrates a diagram of an electronic device 100, in accordance with examples of the present disclosure.

The electronic device 100 includes a first portion 102 including a display 103 and a second portion 104. In some examples, the first portion 102 includes a lid portion with the display 103 and the second portion 104 includes a base portion with circuitry and a user-interface device such as a keyboard, trackpad, or touchscreen. In some such examples, the electronic device 100 may include a laptop computer or notebook. However, examples are not so limited, and the electronic device 100 may include a tablet, smartphone, electronic reader, or other electronic devices that has a display 103 on a first portion 102, with the second portion 104 including an attachment piece, such as a user-interface device or protective cover which is movably coupled to the first portion 102.

A hinge 106 movably couples the first portion 102 to the second portion 104. For example, the first portion 102 is moveable between an open position and a closed position with respect to the second portion 104. Although the above example describes the first portion 102 moving, examples may include the second portion 104 moving. As used herein, an open position of the first portion 102 with respect to the second portion 104 of the electronic device 100 includes and/or refers to the first portion 102 being a threshold distance away from the second portion 104 of the electronic device 100. In some examples, while in the open position, the display 103 and/or a keyboard is accessible and/or visible by the user. A closed position of the first portion 102 with respect to the second portion 104 of the electronic device 100, as used herein, includes and/or refers to the first portion 102 being proximate to the second portion 104, such that the second portion 104 impedes access to the display 103 of the first portion 102. The open position and/or closed position of the first portion 102 is sometimes herein interchangeably referred to as an open position or closed position of the electronic device 100.

The electronic device 100 further includes a flex-protection mechanism 108. The flex-protection mechanism 108 includes a first magnetic component 110, a retractable bumper 112 coupled to a second magnetic component 113, and a third magnetic component 114. As used herein, a “magnetic component” includes and/or refers to a component that generates a magnetic field and/or that acts on or is attracted to a magnetic field. Example magnetic components include a permanent magnet, a non-permanent magnet, such as an electromagnet, and a ferrous material. In some examples, the first magnetic component 110 and the third magnetic component 114 include permanent magnets, and the second magnetic component includes a ferrous material. In some examples, each of the first magnetic component 110, the second magnetic component 113, and the third magnetic component 114 include a permanent magnet. However, examples are not so limited.

The magnetic components 110, 113, 114 may be positioned to cause magnetic interactions to occur and cause movement of the retractable bumper 112. For example, the components 110, 112, 113, 114 of the flex-protection mechanism 108 are positioned such that, in response to movement of the first portion 102 between the open position and the closed position, magnetic interactions occur between the second magnetic component 113, the first magnetic component 110, and the third magnetic component 114, and the retractable bumper 112 moves between a retracted position and a protruded position. As an example, the first magnetic component 110 may be positioned to attract the second magnetic component 113 of the retractable bumper 112 toward the first magnetic component 110 and cause the retractable bumper 112 to move or transition to the retracted position in response to the first portion 102 being in the open position. The third magnetic component 114 may be positioned to attract the second magnetic component 113 of the retractable bumper 112 toward the third magnetic component 114 and cause the retractable bumper 112 to move or transition to the protruded position in response to the first portion 102 being in the closed position.

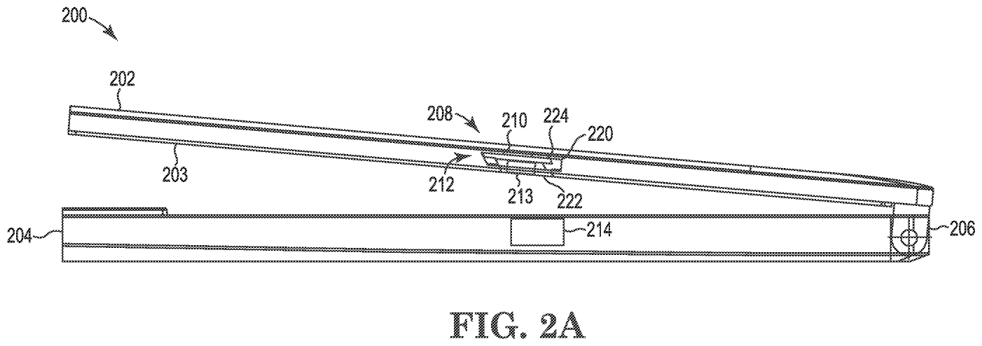

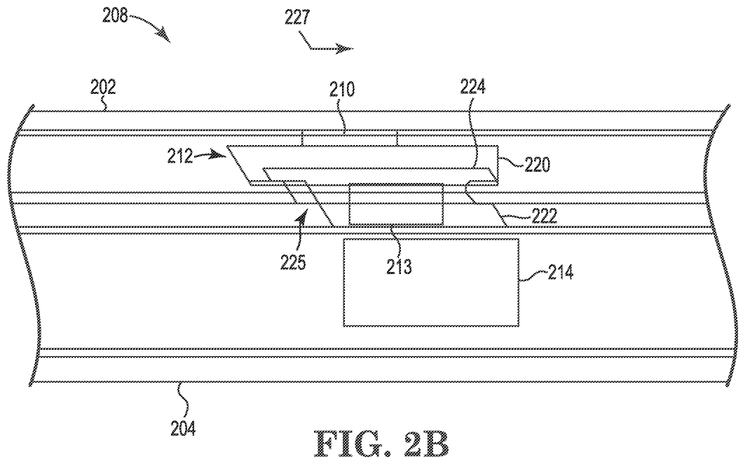

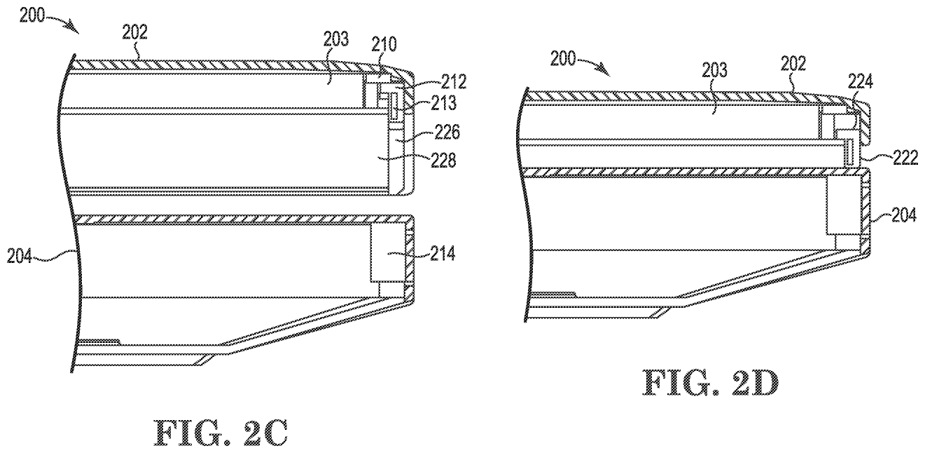

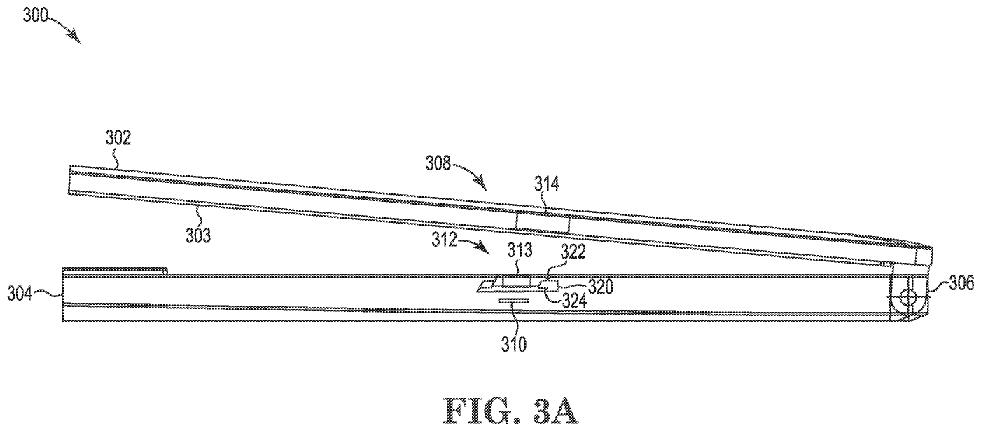

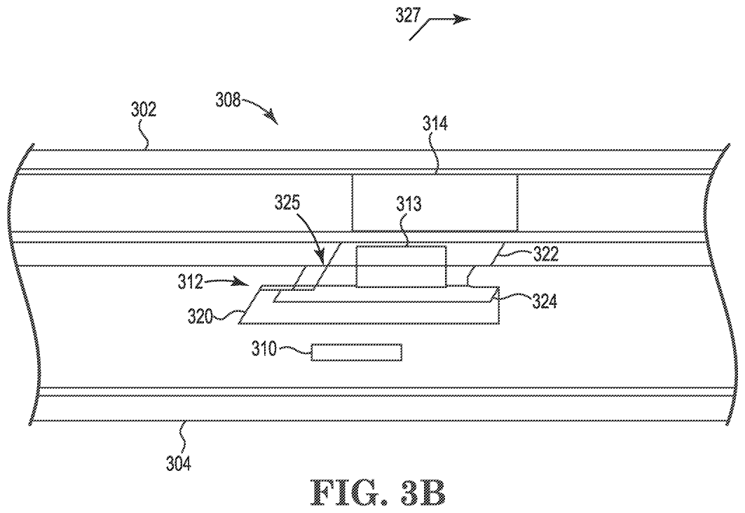

In some examples, the first magnetic component 110 provides a first magnetic force and the third magnetic component 114 provides a second magnetic force. The second magnetic component 113 of the retractable bumper 112 may be attracted to the first magnetic force and the second magnetic force. For example, as illustrated by FIG. 2A and 3A, in response to the first portion 102 being in the open position, the second magnetic component 113 of the retractable bumper 112 is attracted toward the first magnetic component 110 via the first magnetic force and the retractable bumper 112 moves to the retracted position. As illustrated by FIGS. 2B and 3B, in response to the first portion 102 being in the closed position, the second magnetic component 113 of the retractable bumper 112 is attracted toward the third magnetic component 114 via the second magnetic force and the retractable bumper 112 moves to the protruded position.

As used herein, the retracted position of the retractable bumper 112 includes and/or refers to a position of the retractable bumper 112 in which the retractable bumper 112 is encapsulated by or at least partially encapsulated by one of the first portion 102 and the second portion 104 of the electronic device 100. The protruded position of the retractable bumper 112 includes and/or refers to the position of retractable bumper 112 in which a portion of the retractable bumper 112 is exposed outside the one of the first portion 102 and the second portion 104 and/or is in contact with the other of the first portion 102 and the second portion 104 of the electronic device 100.

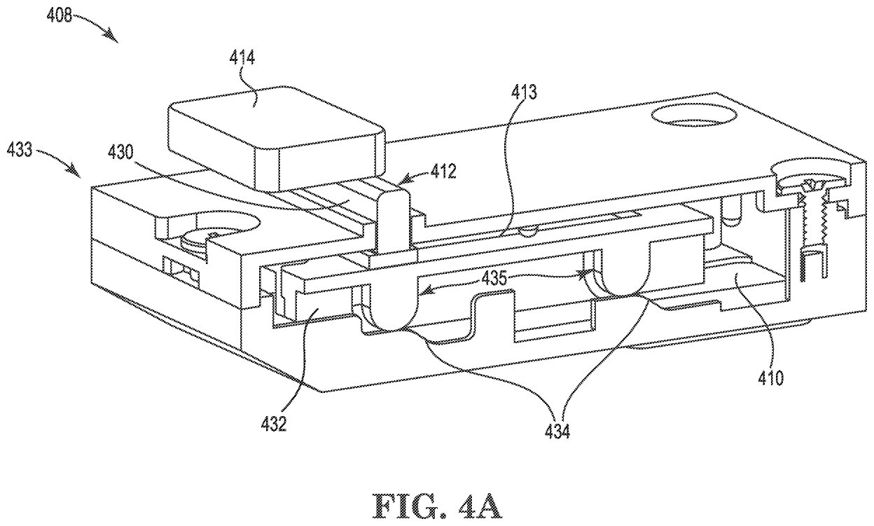

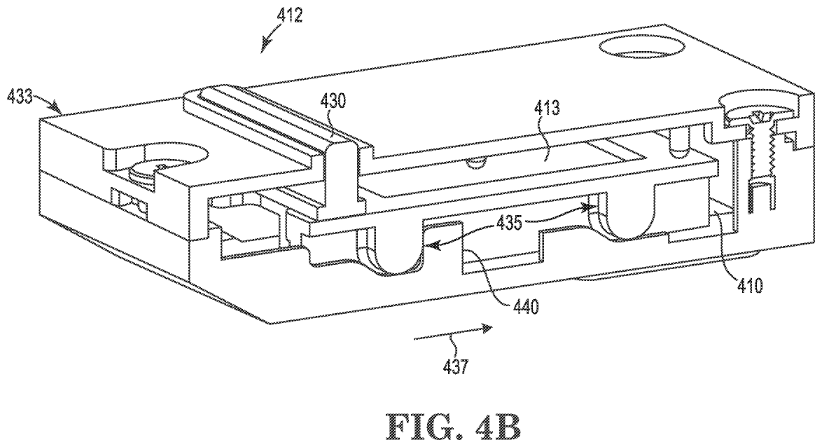

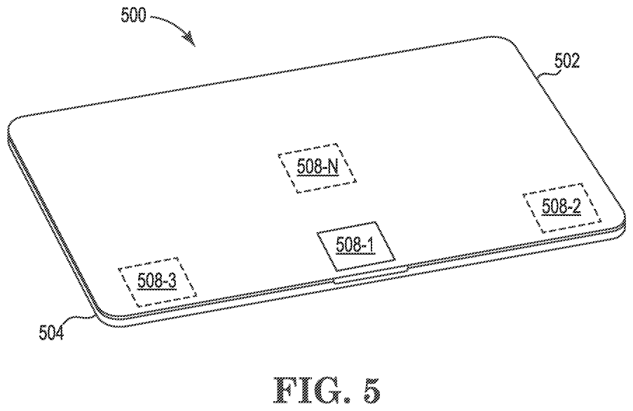

The electronic device 100 may include various additional components and/or variations from that described above. For example, and as further illustrated herein, the electronic device 100 may include a cavity in one of the first portion 102 and the second portion 104 of the electronic device 100 to house the retractable bumper 112, as illustrated by FIGS. 2A-3B. In some examples, the retractable bumper 112 includes a bumper portion that protrudes and retracts from the one of the first portion 102 and second portion 104, the bumper portion being coupled to an extension portion that restricts protraction of retractable bumper 112 from the cavity. In other examples, a frame may house the retractable bumper 112 which may be disposed in the cavity, such as illustrated by FIGS. 4A-4B. The frame may guide movement of the retractable bumper 112. The retractable bumper 112 and first magnetic component 110 may be disposed within the first portion 102 and the third magnetic component 114 may be disposed within the second portion 104, or vice versa. Although FIG. 1 illustrates one flex-protection mechanism 108, example electronic devices may include a plurality of flex-protection mechanisms located at different locations, as further shown by FIG. 5.

FIGS. 2A-2D illustrate an electronic device 200, in accordance with examples of the present disclosure. In some examples, the electronic device 200 of FIGS. 2A-2D may include an implementation of the example electronic device 100 of FIG. 1, and includes a first portion 202 including a display 203, a second portion 204, a hinge 206, and a flex-protection mechanism 208 including a first magnetic component 210, a retractable bumper 212 including a second magnetic component 213, and a third magnetic component 214, as previously described in connection with FIG. 1. For ease of reference, the details of the various features and components are not repeated.

In some examples, the retractable bumper 212 includes a bumper portion 222 that protrudes and retracts, and an extension portion 224 coupled to the bumper portion 222. The extension portion 224 may restrict protraction of the retractable bumper 212, such as restricting movement past a portion of a cavity 220, as further described herein.

In some examples, the retractable bumper 212 and the first magnetic component 210 are coupled to and/or disposed in the first portion 202 of the electronic device 200, and the third magnetic component 214 is coupled to and/or disposed in the second portion 204 of the electronic device. For example, the electronic device 200 may include a cavity 220 in the first portion 202 to house the retractable bumper 212.

More specifically, FIG. 2A illustrates the first portion 202 of the electronic device 200 in the open position. When the first portion 202 is in the open position, the retractable bumper 212 is in the retracted position in which the retractable bumper 212 is within the cavity 220. In some examples, while in the retracted position, the retractable bumper 212 may not be exposed outside the first portion 202 and/or is hidden from view.

FIG. 2B shows a close-up view of the flex-protection mechanism 208 of the electronic device 200 of FIG. 2A while the first portion 202 of the electronic device 200 is in the closed position. When the first portion 202 is in the closed position, the retractable bumper 212 is in the protruded position in which a portion of the retractable bumper 212 extends outside the cavity 220 and is in contact with the second portion 204 of the electronic device 200. As shown by FIG. 2B, the portion extending outside the cavity 220 includes the bumper portion 222 and the second magnetic component 213 may be disposed proximal to or within the bumper portion 222. As further shown by FIG. 2B, the extension portion 224 may restrict protraction of the retractable bumper 212 past a threshold from an opening 225 of the cavity 220. In some examples, the bumper portion 222 may be a first length that is less than a length of the opening 225 of the cavity 220 and the extension portion 224 may be a second length than is greater than the length of the opening 225.

In some examples, when the first portion 202 of the electronic device 200 is in the open position, as illustrated by FIG. 2A, the second magnetic component 213 of the retractable bumper 212 may be attracted to or toward the first magnetic component 210 coupled to the first portion 202 of the electronic device 200. When the first portion 202 of the electronic device 200 is in or moves toward the closed position, as illustrated by FIG. 2B, the second magnetic component 213 of the retractable bumper 212 may be attracted to or toward the third magnetic component 214 coupled to the second portion 204 of the electronic device 200. The third magnetic component 214 may provide a second magnetic force that is greater than a first magnetic force provided by the first magnetic component 210. As the retractable bumper 212 gets closer to the third magnetic component 214, the second magnetic force may overpower the first magnetic force, and the retractable bumper 212 moves in the direction of arrow 227.

FIGS. 2C and 2D illustrates front views of the electronic device 200 of FIG. 2A. More particularly, FIG. 2C shows the first portion 202 of the electronic device 200 in the open position and FIG. 2D shows the first portion 202 of the electronic device 200 in the closed position from a front view. As shown by FIG. 2C, when the first portion 202 of the electronic device 200 in the open position, the retractable bumper 212 and second magnetic component 213 are located proximal to a bezel 226 of the first portion 202 of the electronic device 200. In such examples, the retractable bumper 212 is hidden from view while the electronic device 200 is in the open position. As used herein, a bezel includes and/or refers to an edge, a frame, and/or a border (e.g., piece of material) around a display of an electronic device, and which may be between the display and a frame of the electronic device.

The display 203 may include glass or another protective surface 228 which is disposed proximal to the second portion 204 when the first portion 202 of the electronic device 200 is in the closed position, as shown by FIG. 2D. When in the closed position, the bumper portion 222 of the retractable bumper 212 moves and is in contact with the second portion 204 of the electronic device 200 to mitigate or prevent flexing of the display 203. In some examples, mitigating or preventing flexing of the display 203 may mitigate or prevent damage (e.g., cracking or other stress) to the display 203. In some examples, flexing of the display 203 may be aesthetically unpleasing to a user.

FIGS. 3A-3B illustrate another electronic device 300, in accordance with examples of the present disclosure. The electronic device 300 of FIGS. 3A-3B includes similar features and components to the electronic device 200 of FIGS. 3A-3B, and includes a first portion 302 including a display 303, a second portion 304, a hinge 306, and a flex-protection mechanism 308 including a first magnetic component 310, a retractable bumper 312 including a second magnetic component 313, and a third magnetic component 214, as previously described in connection with FIGS. 2A-2D. As previously described, the retractable bumper 312 includes a bumper portion 322 that protrudes and retracts, and an extension portion 324 that restricts protraction of the bumper portion 322 past an opening 325 of the cavity 320. For ease of reference, the details of the various features and components are not repeated.

As illustrated by FIGS. 3A-3B, in some examples, the retractable bumper 312 and the first magnetic component 310 are coupled to and/or disposed in the second portion 304 of the electronic device 300, and the third magnetic component 314 is coupled to and/or disposed in the first portion 302 of the electronic device 300. For example, the electronic device 300 may include a cavity 320 in the second portion 304 to house the retractable bumper 312.

More specifically, FIG. 3A illustrates the first portion 302 of the electronic device 300 in the open position. When the first portion 302 is in the open position, the retractable bumper 312 is in the retracted position in which the retractable bumper 312 is within the cavity 320. In some examples, while in the retracted position, the retractable bumper 312 may not be exposed outside the second portion 304.

FIG. 3B shows a close-up view of the retractable bumper 312 of the electronic device 300 of FIG. 3A while the first portion 302 of the electronic device 300 is in the closed position. When the first portion 302 is in the closed position, the retractable bumper 312 is in the protruded position in which a portion of the retractable bumper 312 extends outside the cavity 320 and is in contact with the first portion 302 of the electronic device 300.

For example, when the first portion 302 of the electronic device 300 is in the open position, as illustrated by FIG. 3A, the second magnetic component 313 of the retractable bumper 312 may be attracted to or toward the first magnetic component 310 coupled to the second portion 304 of the electronic device 300. When the first portion 302 of the electronic device 300 is in or moves toward the closed position, as illustrated by FIG. 3B, the second magnetic component 313 of the retractable bumper 312 may be attracted to or toward the third magnetic component 314 coupled to the first portion 302 of the electronic device 300. As previously described, the second magnetic component 314 may provide a second magnetic force that is greater than a first magnetic force provided by the first magnetic component 310. As the retractable bumper 312 gets closer to the second magnetic component 314, the second magnetic force may overpower the first magnetic force, and the retractable bumper 312 moves in the direction of arrow 327.

FIGS. 4A-4B illustrate a flex-protection mechanism 408, in accordance with examples of the present disclosure. The flex-protection mechanism 408 may be implemented in any of the electronic devices 100, 200, 300 illustrated by FIGS. 1-3B. For example, the flex-protection mechanism 408 may be implemented in an electronic device 100 that includes a first portion 102 including a display 103, a second portion 104, a hinge 106, as illustrated by and referring to FIG. 1, and a flex-protection mechanism 408 including a first magnetic component 410, a retractable bumper 412 including a second magnetic component 413, and a third magnetic component 414, as previously described in connection with FIG. 1 and referring to FIG. 4A. For ease of reference, the details of the various features and components are not repeated.

In some examples, the flex-protection mechanism 408 includes a frame 433 to house the retractable bumper 412. The frame 433 is coupled to one of the first portion and second portion of the electronic device (e.g., first portion 202, 302 and second portion 204, 304 of FIGS. 2A-2D). The frame 433 may be disposed within a cavity (e.g., cavity 220 or 320 of FIGS. 2A-3D) in one of the first portion and the second portion of the electronic device (e.g., electronic device 200, 300 of FIGS. 2A-3D). The frame 433 includes a set of guide ramps 434 to guide movement of the retractable bumper 412.

The retractable bumper 412 may include a bumper arm 430 coupled to a slider frame 432. The slider frame 432 may extend along the frame 433 and may move along the set of guide ramps 434. In some examples, the slider frame 432 may include a set of protruding components 435 that interact with the guide ramps 434.

As previously described with respect to FIGS. 2A-2D, in some examples, the retractable bumper 412 and the first magnetic component 410 are coupled to and/or disposed in the first portion (e.g., 202 of FIGS. 2A-2D) of the electronic device (e.g., 200), and the third magnetic component 414 is coupled to and/or disposed in the second portion (e.g., 204) of the electronic device (e.g., 200). For example, a cavity (e.g., 220) may be located in the first portion (e.g., 202) of the electronic device to house the frame 433 and the retractable bumper 412. In some such examples, the frame 433 and the first magnetic component 410 are coupled to the first portion of the electronic device proximal to the cavity.

In other examples and as described with respect to FIGS. 3A-3B, the retractable bumper 412 and the first magnetic component 410 are coupled to and/or disposed in the second portion (e.g., 304 of FIGS. 3A-3B) of the electronic device (e.g., 300), and the third magnetic component 414 is coupled to and/or disposed in the first portion (e.g., 302) of the electronic device (e.g., 300). For example, a cavity (e.g., 320) may be located in the second portion (e.g., 304) of the electronic device to house the frame 433 and the retractable bumper 412. In such examples, the frame 433 and the first magnetic component 410 are coupled to the second portion of the electronic device.

More specifically, FIG. 4A illustrates the flex-protection mechanism 408 while the retractable bumper 412 is in the protruded position. As previously described, the retractable bumper 412 may be in the protruded position when the first portion of the electronic device is in the closed position. When the retractable bumper 412 is in the protruded position, the bumper arm 430 of the retractable bumper 412 extends outside one of the first portion and the second portion of the electronic device in which the retractable bumper 412 is housed (e.g., outside cavity 220 or 320 of FIGS. 2A-2D, FIG. 3A-3B) and is in contact with the other of the first portion and second portion of the electronic device. The frame 433 may restrict protraction of the retractable bumper 412 past a threshold from the cavity.

FIG. 4B illustrates a portion of the flex-protection mechanism 408 while the retractable bumper 412 is in the retracted position. As previously described, the retractable bumper 412 may be in the retracted position when the first portion of the electronic device is in the open position. When the retractable bumper 412 is in the retracted position, the bumper arm 430 of the retractable bumper 412 may retract within and/or not extend outside one of the first portion and the second portion of the electronic device in which the retractable bumper 412 is housed (e.g., outside cavity 220 or 320 of FIGS. 2A-2D, FIG. 3A-3B).

As an example, when retractable bumper 412 moves from the protruded position, as illustrated by FIG. 4A, to the retracted position, as illustrated by FIG. 4B, the second magnetic component 413 of the retractable bumper 412 may be attracted to or toward the first magnetic component 410 coupled to the same portion of the electronic device as the retractable bumper 412, thus moving the retractable bumper 412 in the direction of arrow 437. In some examples, the frame 433 may include an elongate arm 440 to restrict further movement of the slider frame 432 in the direction of the arrow 437. When the retractable bumper 412 moves from the retracted position, as illustrated by FIG. 4B, to the protracted position, illustrated by FIG. 4A, the second magnetic component 413 of the retractable bumper 412 may be attracted to or toward the third magnetic component 414, shown by FIG. 4A, coupled to the other portion of the electronic device. The third magnetic component 414 may provide a second magnetic force that is greater than a first magnetic force provided by the first magnetic component 410, such that the retractable bumper 212 moves in the opposite direction of arrow 437.

FIG. 5 illustrates another electronic device 500, in accordance with examples of the present disclosure. The electronic device 500 of FIG. 5 includes similar features and components to the electronic device 100 of FIG. 1, including a first portion 502 including a display, a second portion 504, a hinge, and a flex-protection mechanism 508-1. For ease of reference, the details of the various features and components are not repeated.

The flex-protection mechanism 508-1 may include similar features and components as previously described in connection with FIGS. 1-4B. Example flex-protection mechanism are not limited to the location illustrated by FIGS. 1-4, and may be located in a variety of different locations on the electronic device 500, such as illustrated by the flex-protection mechanisms 508-1, 508-2, 508-3 . . . 508-N. For example, the flex-protection mechanism(s) 508-1 may be located along a perimeter of the electronic device 500, proximal to an end that is opposite the hinge of the electronic device 500, proximal to a keyboard or a middle of the electronic device 500, among other locations. In some examples, an electronic device 500 may include a plurality of flex-protection mechanisms 508-1, 508-2, 508-3 . . . 508-N disposed around the electronic device 500, with each of the plurality of flex-protection mechanisms 508-1, 508-2, 508-3 . . . 508-N including similar features and components as previously described in connection with FIGS. 1-4B.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. An electronic device comprising:
a first portion including a display;
a second portion;
a hinge movably coupling the first portion to the second portion, such that the first portion is movable between an open position and a closed position with respect to the second portion; and
a flex-protection mechanism including:
a first magnetic component;
a retractable bumper coupled to a second magnetic component; and
a third magnetic component, wherein in response to movement of the first portion between the open position and the closed position and magnetic interactions between the second magnetic component, the first magnetic component, and the third magnetic component, the retractable bumper moves between a retracted position and a protruded position.

2. The electronic device of claim 1, wherein:
the first magnetic component is positioned to attract the second magnetic component of the retractable bumper toward the first magnetic component and cause the retractable bumper to slide to the retracted position in response to the first portion being in the open position; and
the third magnetic component is positioned to attract the second magnetic component of the retractable bumper toward the third magnetic component and cause the retractable bumper to slide to the protruded position in response to the first portion being in the closed position.

3. The electronic device of claim 1, wherein:
the first magnetic component provides a first magnetic force;
the third magnetic component provides a second magnetic force that is greater than the first magnetic force; and
the second magnetic component is attracted to the first magnetic force and the second magnetic force.

4. The electronic device of claim 1, further including a cavity in the first portion of the electronic device to house the retractable bumper, wherein:
the first magnetic component is coupled to the first portion of the electronic device;
the third magnetic component is coupled to the second portion of the electronic device;
the retracted position of the retractable bumper includes the retractable bumper being within the cavity; and
the protruded position of the retractable bumper includes a portion of the retractable bumper extending outside the cavity and being in contact with the second portion.

5. The electronic device of claim 4, wherein the retractable bumper and the second magnetic component are located proximal to a bezel of the first portion.

6. The electronic device of claim 1, further including a cavity in the second portion of the electronic device to house the retractable bumper, wherein:
the first magnetic component is coupled to the second portion of the electronic device;
the third magnetic component is coupled to the first portion of the electronic device;
the retracted position of the retractable bumper includes the retractable bumper being within the cavity; and
the protruded position of the retractable bumper includes a portion of the retractable bumper extending outside the cavity and being in contact with the first portion.

7. The electronic device of claim 1, further including:
a cavity in one of the first portion and the second portion of the electronic device;
a frame to house the retractable bumper and disposed within the cavity, the frame including a set of guide ramps to guide the movement of the retractable bumper; and
wherein the retractable bumper includes a bumper arm coupled to a slider frame, the slider frame to extend along the frame and to move along the set of guide ramps.

8. The electronic device of claim 1, further including a cavity in one of the first portion and the second portion of the electronic device to house the retractable bumper, wherein the retractable bumper includes a bumper portion that protrudes and retracts from the one of the first portion and second portion, the bumper portion being coupled to an extension portion that restricts protraction of retractable bumper from the cavity.

9. An electronic device comprising:
a first portion including a display;
a second portion;
a hinge movably coupling the first portion to the second portion, such that the first portion is movable between an open position and a closed position with respect to the second portion; and
a flex-protection mechanism including:
a first magnetic component;
a retractable bumper coupled to a second magnetic component, the retractable bumper including:
a bumper portion that protrudes and retracts; and
an extension portion coupled to the bumper portion that restricts protraction of retractable bumper; and
a third magnetic component, wherein in response to the first portion moving between the open position and the closed position and magnetic interactions between the second magnetic component, the first magnetic component, and the third magnetic component, the retractable bumper moves between a retracted position and a protruded position.

10. The electronic device of claim 9, further including a cavity in the first portion of the electronic device to house the retractable bumper, wherein:
the first magnetic component is coupled to the first portion of the electronic device proximal to the cavity; and
the third magnetic component is coupled to the second portion of the electronic device.

11. The electronic device of claim 9, further including a cavity in the second portion of the electronic device to house the retractable bumper, wherein:
the first magnetic component is coupled to the second portion of the electronic device; and
the third magnetic component is coupled to the first portion of the electronic device proximal to the cavity.

12. An electronic device comprising:
a first portion including a display;
a second portion;
a hinge movably coupling the first portion to the second portion, such that the first portion is movable between an open position and a closed position with respect to the second portion; and
a flex-protection mechanism including:
a first magnetic component;
a frame to house a retractable bumper coupled to one of the first portion and second portion of the electronic device, the frame including a set of guide ramps to guide movement of the retractable bumper;
wherein the retractable bumper is coupled to a second magnetic component, the retractable bumper including a bumper arm coupled to a slider frame, the slider frame to extend along the frame and to move along the set of guide ramps; and
a third magnetic component, wherein in response to the first portion moving between the open position and the closed position and magnetic interactions between the second magnetic component, the first magnetic component, and the third magnetic component, the retractable bumper moves between a retracted position and a protruded position.

13. The electronic device of claim 12, wherein the slider frame includes a set of protruding components that interact with the set of guide ramps.

14. The electronic device of claim 12, further including a cavity in the first portion of the electronic device to house the frame and the retractable bumper, wherein:
the frame is coupled to the first portion of the electronic device;
the first magnetic component is coupled to the first portion of the electronic device proximal to the cavity; and
the third magnetic component is coupled to the second portion of the electronic device.

15. The electronic device of claim 12, further including a cavity in the second portion of the electronic device to house the frame and the retractable bumper, wherein:
the frame is coupled to the second portion of the electronic device;
the first magnetic component is coupled to the second portion of the electronic device; and
the third magnetic component is coupled to the first portion of the electronic device proximal to the cavity.
